(19) United States
(12) Patent Application Publication
(10) Pub. No.: US 2010/0135630 A1
(43) Pub. Date: Jun. 3, 2010

(54) CABLE DUCT RESTRAINING DEVICE

(76) Inventor: David Frederick Hawkins, Middlesex (GB)

Correspondence Address: HESLIN ROTHENBERG FARLEY & MESITI PC, 5 COLUMBIA CIRCLE, ALBANY, NY, 12203, US

(21) Appl. No.: 12/526,159

(22) PCT Filed: Feb. 7, 2008
(86) PCT No.: PCT/GB2008/000441

§ 371 Date: Feb. 4, 2010

(30) Foreign Application Priority Data
Feb. 7, 2007 (GB) 0702409.4

(51) Int. Cl. G02B 6/44; F16L 3/00

(52) U.S. Cl. 385/135; 248/49

(57) ABSTRACT

The invention provides a restraining device for restraining a cut microduct end against longitudinal movement in an outer protective duct, the device comprising a body having one or more openings through which uncut microducts can pass and means for anchoring a cut end of a microduct to the body.

This invention relates to a device for restraining or preventing movement of cut microduct ends in a fibre optics communications line and to a method of preventing migration and loss of cut microduct ends, and the resulting loss of network capacity.

### BACKGROUND OF THE INVENTION

A widely used method of creating fibre optic communication lines is to install a bundle of relatively narrow bore ducts commonly known as microducts in a larger bore protective duct or pipe and then install individual optical cables in each microduct. The larger bore protective duct or pipe may be an existing underground pipe or duct or may be a pipe or duct installed for the purpose. A technique used increasingly for installing the individual optical cables into the microducts is the method known as “jetting” or “blowing” in which the cables are driven along the microducts using compressed air.

In order to install a branch connection in a fibre optics communications line, a window or break is cut in the outer protective duct and one or more microducts (depending on the number of cables required for the branch connection) in the bundle are cut. The cut ends on the upstream side of the cut are then connected by means of standard connectors to lengths of microduct that branch off to the desired location. Cables can then be blown through the branch microducts without the need for any splicing of the cable.

Whilst effective, this method does have the disadvantage that it leaves a number of loose ends on the downstream side of the cuts in the microducts. It is a common occurrence that the loose ends of the microducts disappear down the protective duct and cannot readily be retrieved or even retrieved at all. This results in the loss of additional cable capacity and also the loss of any future-proofing when upgrades are desirable in populated ducts. Longitudinal movement of the microducts along the protective outer ducts can be caused by a number of factors, for example as a result temperature variations experienced in the field, by stresses induced during the manufacturing process and also movement caused by land slippage or dig-up.

It will be appreciated that in a fibre optics cable network having a large number of branches, there may be many kilometres of loose and unusable cut microduct within the protective outer ducts giving rise to a substantial loss of capacity. It would therefore be extremely beneficial to be able to secure any unused microduct to prevent the loss of available capacity in the network and thereby preserve the commercial advantages of blown fibre/cables over conventional methods of fibre optics cable installation.

### SUMMARY OF THE INVENTION

The present invention provides a solution to the problem of the migration of cut microducts by means of a device that anchors the cut ends of microducts.

Accordingly, in a first aspect, the invention provides a restraining device for restraining a cut microduct end against longitudinal movement in an outer protective duct, the device comprising a body having one or more openings through which uncut microducts can pass and means for anchoring a cut end of a microduct to the body.

The body should be capable of being positioned (e.g. wrapped) about the uncut microducts without the need for an end of the uncut microduct to be threaded through the body. This may be accomplished, for example, by providing the body with one or more (and preferably a plurality) of open sided slots or grooves that extend longitudinally through the body. In another embodiment, the body may be formed from a plurality of members that may be separated to enable them to be positioned about the uncut microducts and then reconnected to surround the microducts. The plurality of members can be separated by partially or completely detaching one from the other. For example, one member may be hingedly connected to another, the hinge being opened so that the members can be positioned about the microducts and then closed to secure the microducts in place.

The body may advantageously take the form of a frame. The frame can be formed from a plurality of frame members that may be separated to enable them to be disposed about the uncut microducts. For example, the frame may comprise a pair of frame members that are either hingedly connected or are replaceably separable to allow them to be disposed about the uncut microducts.

In one embodiment, the frame comprises a pair of replaceably separable or hingedly connected frame members, a first of the frame members in the pair having one or more open ended slots therein through which an uncut microduct may pass, wherein the second frame member in the pair is connectable to the first frame member to close the said one or more open ended slots.

The loose ends of the cut microducts can be anchored to the body (e.g. a frame) in a variety of ways. In one preferred embodiment, however, the end of the cut microduct has a connector attached thereto, and the frame is provided with means for anchoring the connector. The means for anchoring the connector may take the form of a plug or socket (or male or female formation) mounted on or formed integrally with the frame that engages the connector. In an alternative form, the means for anchoring the connector may take the form of one or more recesses (e.g. grooves) or protrusions on a radially outer surface of the connector that engage a complementary protrusion or recess on the frame. For example, the connector may have a pair of parallel grooves, one either side of an end thereof, the parallel grooves serving to engage the edges of a slot in the frame.

The term “connector” as used herein is used in a general sense and is not limited to connectors of the type used to connect one length of duct to another. Thus, for example, the term also covers connectors used to connect an length of duct with a cabinet or enclosure, or an item of equipment, as well as terminal or end stop connectors and plugs. The connectors may be provided with gas-tight or water-tight sealing properties or may be substantially unsealed.

The frame is typically formed from a plastics material although it could alternatively be formed from a metal. Where the frame is formed in two or more replaceably separable pieces, the plastics material may be chosen so that it is sufficiently stiff to provide structural rigidity but is sufficiently resilient to enable the separable pieces to be secured together by means of a snap fit connection.

The restraining devices of the invention may be used at any microduct manipulation point. Thus, for example, they may be used to tether microducts in manholes, handholes, exchanges, points of entry into buildings, nodes and branch points on communications networks, cabinets, and other forms of enclosure containing microduct assemblies. Thus the restraining devices are transportable and are usable at a wide range of different locations on a network.

In another aspect, the invention provides an enclosure for surrounding a fibre optics cable, the enclosure containing a restraining device as defined herein.

The enclosure may take the form of a casing having an opening at an end (and typically both ends) thereof for receiving an end of a protective outer duct. The connection to the protective outer duct may be an unsealed or a sealed connection.

The casing may be provided with one or more further openings for receiving one or more protective outer ducts of a branched cable.

The casing may comprise a plurality (e.g. a pair) of casing members configured to be secured together about the microducts. The casing members may be secured to together by any suitable fastening means, for example by screws, bolts, ties, bands or like fastenings or by means of a snap fit. In one embodiment, the casing members are secured together by means of split caps at either end thereof, wherein the split caps are each configured to surround an end of a protective outer duct.

In a further aspect, the invention provides a method of forming a branch in a fibre optics communication line, wherein the fibre optics communication line comprises a protective outer duct surrounding a plurality of microducts, each microduct being capable of accommodating a fibre optics cable; the method comprising removing a portion of the protective outer duct, cutting one or more microducts, connecting the upstream cut end of each cut microduct to another length of microduct to form a branch and securing each downstream cut end of the microduct to a restraining device as defined herein.

Further aspects of the invention will be apparent from the specific description below and the drawings appended hereto.

### BRIEF DESCRIPTION OF THE DRAWINGS

FIG. 1 is a perspective view of a cable branch enclosure containing a cable duct restraint according to one embodiment of the invention.

FIG. 2 is a perspective view of part of the enclosure of FIG. 1 showing the cable duct restraint in position and a number of cable ducts anchored to the restraint.

FIG. 3 is a perspective view similar to FIG. 3 but with the cable duct restraint rotated through 90 degrees and showing cable ducts passing through the cable duct restraint and cable ducts anchored to the cable duct restraint.

FIG. 4 is a perspective view of the enclosure of FIG. 1 with a part of the wall cut away to show the interior.

FIG. 5 is a perspective view from another angle of the of the cut away enclosure of FIG. 4.

FIG. 6 is a perspective view from another angle of the of the cut away enclosure of FIG. 4 but showing uncut microducts passing through the enclosure as well as anchored cut ends of microducts.

FIG. 7 is a perspective view of a cable duct restraint secured about a plurality of cable ducts.

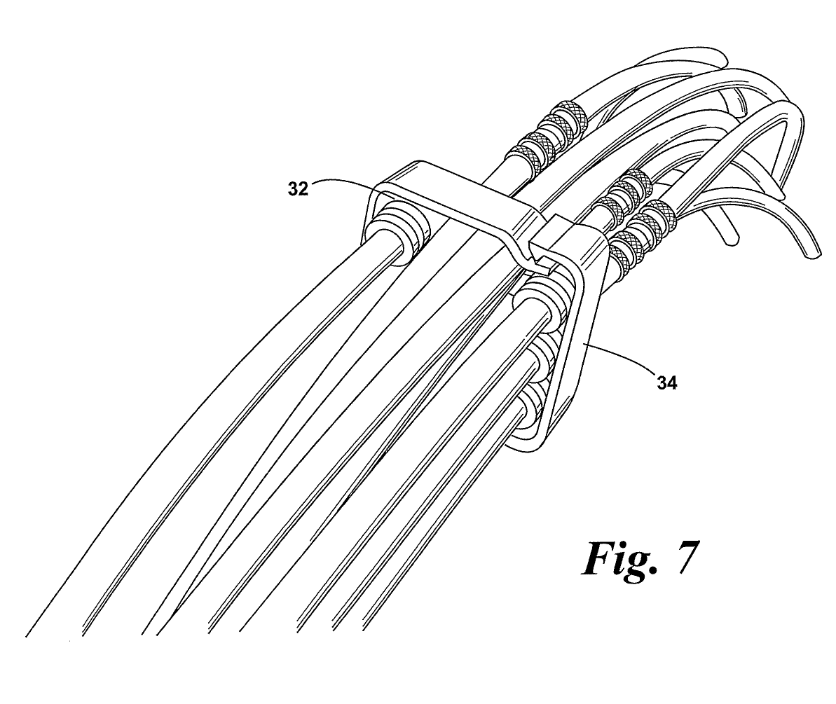

FIG. 8 is a perspective view from one side of a cable duct restraint having a number of cable ducts anchored thereto.

FIG. 9 is a schematic view of part of a cable duct restraint showing a method of anchoring a cable duct end connector in the restraint.

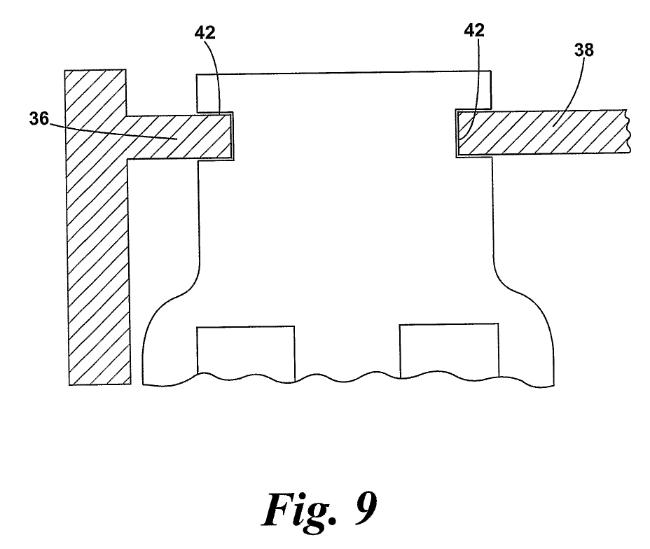

### DETAILED DESCRIPTION OF THE INVENTION

The invention will now be illustrated in greater detail, but not limited, by reference to the specific embodiments illustrated in the drawings.

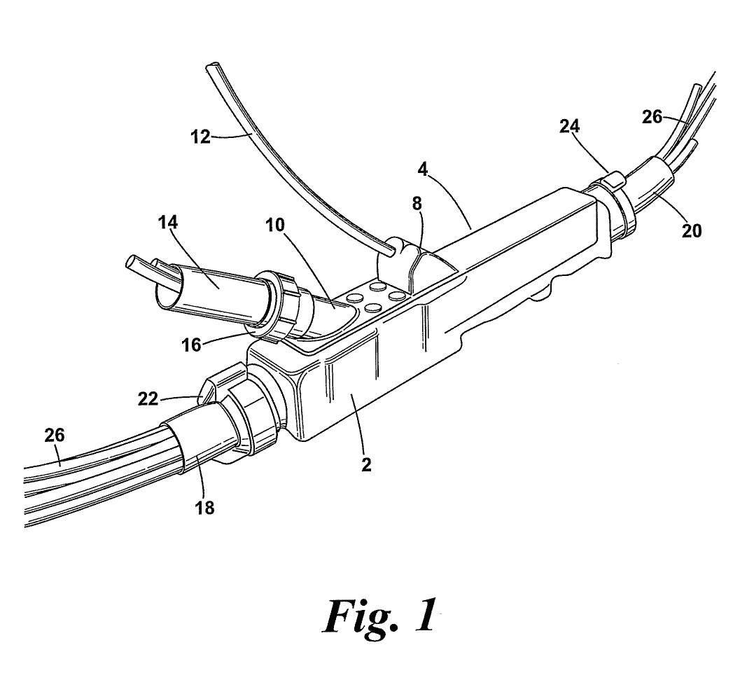

FIG. 1 shows a cable branch enclosure of a type for use in a fibre optics communications network. The enclosure comprises a casing formed from a pair of casing members 2 and 4 moulded from a suitable plastics material and secured together by means of split caps 22 and 24 at either end. Casing member 4 is provided with branch formations 8 and 10 from which extend a narrow bore pipe 12 and a wider bore protective pipe 14. A split cap 16 can be used to hold the pipe 12 in place.

Protective outer ducts or pipes 18 and 20 are received within the two ends of the casing. A bundle of microducts 26 is carried by the pipes 18 and 20, some of the microducts passing right through the casing and others terminating in the casing and being anchored as described below.

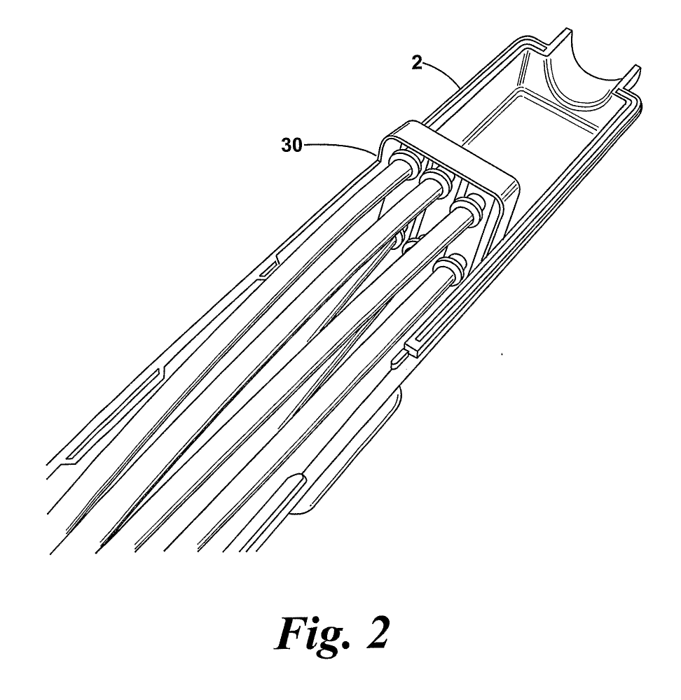

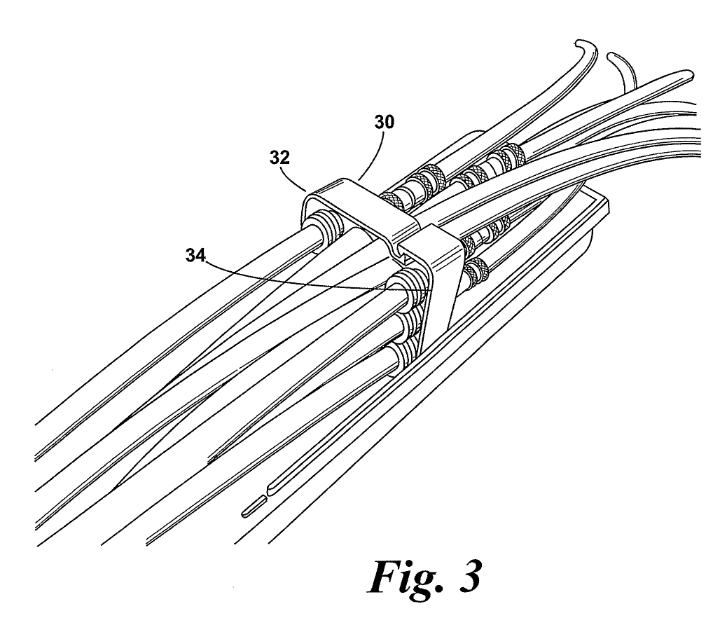

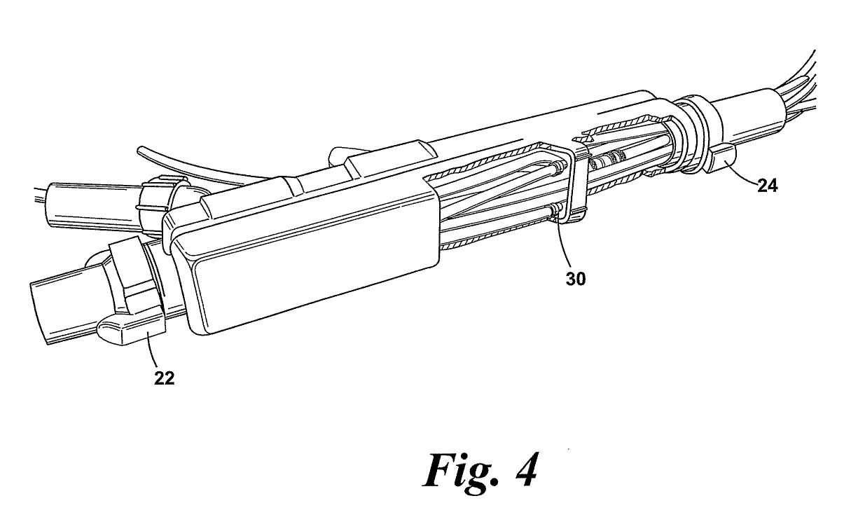

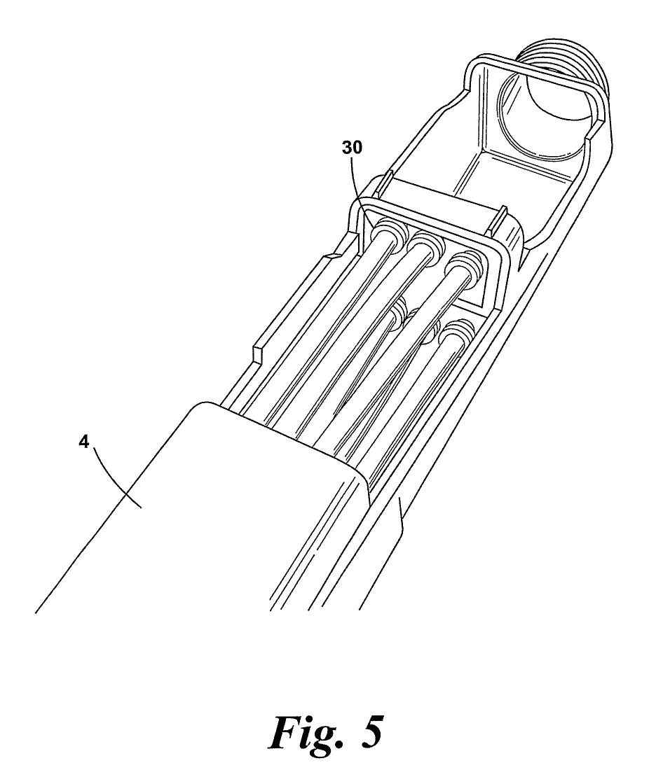

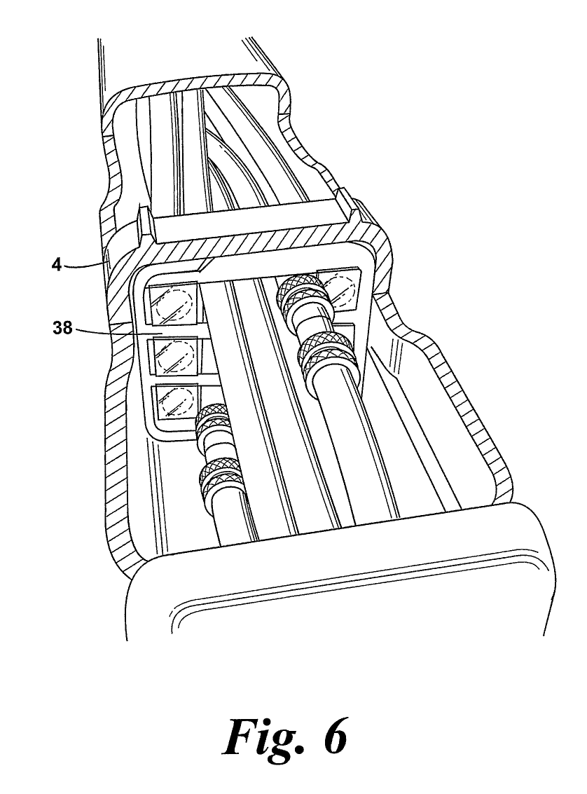

The interior of the casing is shown in FIGS. 2 to 6. Located within the casing is cable duct restraint 30 which, in this embodiment, takes the form of a rectangular frame, the shape of which is chosen so as to fit snugly within the interior of the casing. The rectangular frame comprises two frame members 32 and 34, each formed of a plastics material and configured to allow them to be coupled together by means of a snap fit to form the frame. As an alternative to a snap fit, cable ties may be used to hold the frame members together, and holes, grooves, ridges or other protrusions may be provided to help anchor the cable ties.

The frame member 36 has an inwardly extending flange 36 to which are connected (i.e. integrally formed with) flat bars 38 that extend from one side of the frame to the other. The flange 36 and bars 38 together define slots 40, the purpose of which is explained below.

An enclosure of the type shown in the drawings can be used to create a branch point in a fibre optic communications line. A typical fibre optic communications line comprises a protective outer duct or pipe of relatively wide bore which in which are installed microducts 26. Microducts 26 carry fibre optics cables which may typically be installed by means of “blowing” or “jetting” methods in which the cable is forced along a microduct by means of compressed air.

In order to create a branch point, for example to provide a new fibre optics cable link to a building, a length of the outer duct or pipe 18/20 is removed to reveal the bundle of microducts inside. The microducts are then cut and a selected number of cut ends on one side of the cut are then connected via standard microduct connectors to new lengths of microduct that will form the branch connection. This procedure leaves a number of loose microduct ends on the other side of the cut. Conventionally, the loose ends have simply been left unsecured inside the connector casing and, as a result of a number of factors, the loose ends will often migrate out of the connector casing and along the outer protective duct and hence cannot be reused.

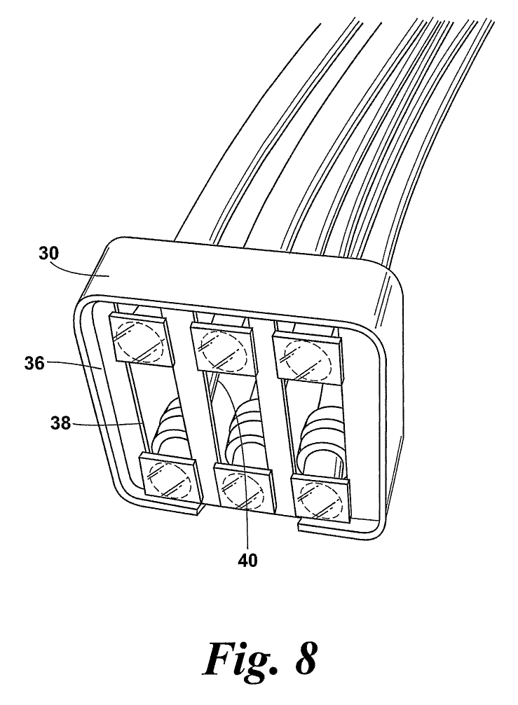

According to the present invention, rather than the cut microduct ends being left loose within the casing, they are secured to the frame 30. Thus, each loose end is attached to a terminal connector, which has a pair of parallel grooves 42, one either side, towards its end, as shown in FIG. 8. The terminal connector can otherwise be of conventional form and may be, for example, a push fit connector containing a grab ring and seal arrangement (not shown) for securing the connector to the microduct.

The two frame members 32 and 34 of the frame are separated and both the uncut microducts and the cut microduct ends bearing the terminal connectors are fed into the slots 40 in the frame member 32. The terminal connectors are inserted into the slots so that the edges of the bar 38 and the flanges 36 engage the grooves, and the connectors slide into place along the bar and flange. The engagement of the grooves with the edges of the bar 38 and the flanges 36 serves to restrain the microducts against longitudinal movement.

Once the uncut microducts and terminal connectors are in place, the frame member 34 is snapped back into place to complete the assembly.

By anchoring the cut microduct ends using the frame 30, migration of the cut ends out of the casing and along the protective outer pipe is prevented. The microducts may therefore subsequently be reused.

### Equivalents

It will readily be apparent that numerous modifications and alterations may be made to the specific embodiments of the invention described above without departing from the principles underlying the invention. All such modifications and alterations are intended to be embraced by this application.

1-11. (canceled)

12. A restraining device for restraining a cut microduct end against longitudinal movement in an outer protective duct, the device comprising a body having one or more openings through which uncut microducts can pass and means for anchoring a cut end of a microduct to the body.

13. A restraining device according to claim 12, wherein the body is formed from a plurality of members that may be separated to enable the separated members to be positioned about the uncut microducts and then reconnected to surround the microducts.

14. A restraining device according to claim 13, wherein the plurality of members that may be separated comprise a plurality of frame members that may be separated to enable the frame members to be disposed about the uncut microducts.

15. A restraining device according to claim 14, wherein the plurality of members that may be separated comprise a pair of one of replaceably separable frame members and hingedly connected frame members, a first of the frame members in the pair having the one or more openings therein through which an uncut microduct may pass, wherein the second frame member in the pair is connectable to the first frame member to close the one or more openings.

16. A restraining device according to claim 12, wherein the means for anchoring the cut end of the microduct to the body comprises a connector attached to the cut end, and means for anchoring the connector to the body.

17. A restraining device according to claim 16, wherein the means for anchoring the connector to the body comprises one or more recesses or protrusions on a radially outer surface of the connector that engage one or more complementary protrusions or recesses on the body.

18. A restraining device according to claim 16, wherein the means for anchoring the connector to the body comprises one or more grooves on a radially outer surface of the connector that engage a complementary protrusion or recess on the body.

19. A restraining device according to claim 16, wherein the connector includes a pair of parallel grooves adapted to engage edges of the one or more openings in the body.

20. An enclosure for surrounding a fibre optics cable, the enclosure containing the restraining device as defined in claim 12.

21. An enclosure according to claim 20, wherein the enclosure comprises a casing having an opening at an end thereof for receiving an end of a protective outer duct.

22. An enclosure according to claim 21, wherein the casing has an opening at both ends thereof for receiving an end of a protective outer duct.

23. A method of forming a branch in a fibre optics communication line, wherein the fibre optics communication line comprises a protective outer duct surrounding a plurality of microducts, each microduct being capable of accommodating a fibre optics cable, the method comprising removing a portion of the protective outer duct, cutting one or more microducts, connecting an upstream cut end of a cut microduct to another length of microduct to form a branch, and securing a downstream cut end of the cut microduct to a restraining device as defined in claim 12.

24. A restraining device according to claim 12, the one or more openings in the body comprise one or more slots.
